(19) United States
(12) Patent Application Publication
(10) Pub. No.: US 2008/0250650 A1
(43) Pub. Date: Oct. 16, 2008

(54) UTILITY KNIFE

(75) Inventors: Brett P. Seber, Vista, CA (US); Eric B. Carmichael, Encinitas, CA (US); Wesley James Tom, Escondido, CA (US)

Correspondence Address: KELLY LOWRY & KELLEY, LLP, 6320 CANOGA AVENUE, SUITE 1650, WOODLAND HILLS, CA, 91367, US

(73) Assignee: I.D.L. TECH TOOLS, LLC, Summit, NJ (US)

(21) Appl. No.: 12/103,337

(22) Filed: Apr. 15, 2008

Related U.S. Application Data
(60) Provisional application No. 60/911,946, filed on Apr. 16, 2007.

(51) Int. Cl. B26B 3/06

(52) U.S. Cl. 30/161; 30/162

(57) ABSTRACT

The utility knife includes a handle and a replaceable blade having a lock retention notch. A blade lock mechanism includes a blade lock associated with the handle which automatically engages the lock retention notch on insertion of the blade into the handle. The blade lock mechanism further includes a means for manually disengaging the blade lock from the lock retention notch in order to remove the blade from the handle.

### BACKGROUND OF THE INVENTION

The present disclosure generally relates to a utility knife. More particularly, the invention relates to a utility knife having a blade lock mechanism for automatically retaining a replaceable blade upon insertion of the blade into the utility knife handle.

Utility knives generally known in the art include replaceable or interchangeable knife or box cutting blades. These knives may include blades that are fixed at one end during assembly and are thereafter continuously exposed. Without a protective guard, the constantly exposed knife blade presents a continuing risk of injury to users and a continual risk of damage to objects that come in contact with the knife blade. This risk exists even when the knife is not in use. These fixed blade knives require disassembly of the knife body to remove or replace a worn out or damaged blade. During disassembly, users risk losing or damaging knife components including the handle, blade, or blade retaining mechanism. In some cases, reassembly is complicated and requires instruction manuals or other special tools and supplies developed by the manufacturer. Such burdens decrease the overall efficient operation, user convenience, and performance of the knife because of the additional time, money, and energy required to replace the utility blade. Disassembly and reassembly are simply an inconvenient burden placed on the end user.

In another utility knife design, the knife handle utilizes a slideably retractable knife blade. In one example, the knife blade includes a continuous multiblade unit that is capable of extension beyond the end of the knife handle through the use of a button mechanism. This mechanism is incorporated into the knife blade handle and is depressed into a channel for slideably extending and retracting the multiblade unit. The individual blades are separated by scorelines located at intermittent intervals along the length of the continuous multiblade unit. Individual blades that wear out, break, or simply need replacement are separated from the continuous multiblade unit along the scorelines separating the individual blades. A new blade previously concealed within the utility knife handle replaces the old blade, once the old blade is separated. The method of replacing blades by means of breaking off worn out or broken blades certainly presents the danger of inadvertent injury to the user or surrounding objects.

In a similar design, the multiblade utility knife may be actuated by a thumbscrew. The thumbscrew is manually operated and requires loosening before the knife is capable of being extended or retracted. Once freed, the thumbscrew mechanism slides lengthwise along the handle to extend or retract the utility knife. The thumbscrew then requires retightening once the utility blade is in the desired position. Typically, both the button mechanism and thumbscrew designs require disassembly of at least a two-piece knife handle to remove and replace the continuous multiblade knife unit.

Other utility blades include designs that enable users to store a rotatable utility blade or box cutting blade in the handle or a portion of the handle thereof. In these designs, the knife blade is mounted to an arm that rotates upon an axis point connected to one end of the utility knife handle. The blade is initially rotated from a stored position concealed within the handle to an extended position wherein the knife is capable of being used as a cutting apparatus. Some designs allow the knife to be locked into place by an engagement mechanism. The locking mechanism prevents inadvertent dislodgement of the knife from the extended position. When not in use, the blade is rotated back to a stored position by unlocking the engagement mechanism, if present, by the use of a button mechanism or the like. The blade then rotates around the pivot point at one end of the blade handle and back into the base of the handle for safe storage. But, for reasons for stability and safety, the utility blade is generally locked into the rotatable arm. Blade replacement therefore requires disassembly of the handle unit or the rotational arm in order to remove and replace the blade. Another disadvantage to this design is that the knife handle and rotatable utility blade arm include a series of mechanical parts. This increases material, manufacturing, and labor costs to develop and assemble the knife unit. Increasing the complexity of the knife blade retention mechanism increases usage difficulties and expense. Again, knife blade replacement may require complicated operation, manufacturer instructions, or special tools.

In still another utility knife design, the knife blade could be automatically retractable by a spring-biasing mechanism. The knife blade automatically retracts into the handle unit upon release of an operating lever. In the retracted position, a spring biases the utility blade carrier unit rearwardly. The carrier unit is released when a user compresses a protruding release mechanism mechanically coupled to the knife blade carrier. The spring releases the utility blade carrier unit, resulting in the extension of the utility blade. Again, these utility knife blade designs typically require manual separation of multiple handle pieces in order to replace worn out or broken blades. In one particular design, the user must remove an outer cover to expose the interior of the knife unit. Removal of the outer cover requires the use of a screwdriver or other tool to dislodge or unscrew the outer cover. Thus, additional tools, time, and handling are required. Such factors all reduce the ease of replacing the knife blade.

Thus, there remains a need for a utility knife incorporating a simple and inexpensive construction that includes a small number of component parts and does not require disassembly of the utility knife to remove or replace the knife blade. Furthermore, the knife blade removal mechanism should be simple and should not require the use of special tools. A quick and easy knife blade engagement and release mechanism is therefore needed for blade replacement or complete blade removal for periods of non-use. The present invention provides such a device.

### SUMMARY OF THE INVENTION

The present invention is directed to a utility knife having a handle with a replaceable blade retained therein. The utility knife includes a blade lock mechanism and a blade lock associated with the handle that automatically engages the lock retention notch of a replaceable blade upon insertion of the blade into the handle. The blade lock mechanism further includes a means for manually disengaging the blade lock from the lock retention notch in order to remove the blade from the handle. In one embodiment, the utility knife handle may further include a guide for aligning the blade within the handle. Alternatively, the utility knife may have an angled handle head further exposing a cutting edge of the blade when inserted in the handle. A debris release channel may also be integrated into the handle to prevent debris from clogging the interior of the handle due to replacement of the utility knife blade.

In an alternative embodiment of the present invention, the blade lock mechanism comprises a spring manually actuable by a lock release mechanism. The lock release mechanism may include a button externally accessible from the handle. Accordingly, the blade is sandwiched between the spring and the lock release mechanism after insertion of the blade into the handle. The blade lock is attached to the handle and automatically engages the lock retention notch of the replaceable blade after insertion. To remove the blade from the handle, the lock release mechanism compresses the spring into a chamber in the handle and depresses the blade within a slot formed in the handle to disengage the lock retention notch from the blade lock. Thereafter, the blade may be removed from the utility knife and replaced. The spring may comprise a cantilever spring, a flat spring or a coil spring.

In another alternative embodiment of the present invention, the blade lock mechanism is pivotally coupled to the handle and comprises a pivotable arm and a spring coupled to a proximate end of the arm. The blade lock is accordingly located on a distal end of the arm. To remove the blade from the handle, the pivotal arm is rotated, compressing the spring, such that the blade lock disengages the lock retention notch of the replaceable blade. In this position, the replaceable blade is removed from the handle. Again, the spring may comprise a cantilever spring, a flat spring or a coil spring.

In a particularly preferred embodiment of the present invention, the handle includes a recess therein for providing access to the proximate end of the arm. The recess is used in association with a collar that prevents access to the proximate end of the arm when the blade moves out from a fully extended position. Thereafter, the blade lock cannot be disengaged from the lock retention notch because the collar prevents access to the proximate end of the arm, which requires depression to remove the blade lock from the lock retention notch. Accordingly, this prevents inadvertent dislodgement of the replaceable blade from within the handle during periods of nonuse.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 illustrates a perspective view of a utility knife of the present invention;

FIG. 2 illustrates an exploded view of a utility knife and the internal knife blade release mechanism of FIG. 1;

FIG. 3 further illustrates an exploded view of the utility knife shown in FIG. 1;

FIG. 4 is an inverted exploded view of the utility knife of FIG. 3;

FIG. 5 illustrates the internal knife blade retention mechanism of a utility knife of FIG. 1;

FIG. 6 is a cross-sectional view of FIG. 1 taken along lines 6-6, illustrating the knife blade in the locked position;

FIG. 7 is a cross-sectional view of FIG. 1 taken along lines 6-6, wherein the knife blade is unlocked by a release button;

FIG. 8 is a perspective view of a prior art utility knife incorporating a known side release mechanism;

FIG. 9 illustrates an exploded view of the utility knife of FIG. 8, illustrating the internal knife blade release mechanism;

FIG. 10 is another exploded view of the utility knife of FIG. 8;

FIG. 11 is a cross-sectional view of FIG. 8 taken along lines 11-11, illustrating the knife blade in the locked position;

FIG. 12 is an alternative view of FIG. 8 taken along lines 11-11, wherein the knife blade is unlocked by a release button;

FIG. 13 is a cross-sectional view of FIG. 8 taken along lines 13-13, illustrating the knife blade in the locked position;

FIG. 14 is a cross-sectional view of FIG. 8 taken along lines 13-13, wherein the knife blade is unlocked by a release button;

FIG. 15 illustrates an alternate embodiment of the present invention, wherein the quick release button is formed as a rocker arm;

FIG. 16 further illustrates the utility knife of FIG. 15, wherein the rocker arm is in the unlocked position;

FIG. 17 illustrates the rocker arm of FIGS. 15-16 perpendicular to a flat spring, and including a debris release lock;

FIG. 18 is a side view of the utility knife of FIG. 15 taken along lines 18-18, illustrating the knife blade in the locked position;

FIG. 19 is a side view of FIG. 14 taken along lines 19-19, wherein the knife blade is in the unlocked position;

FIG. 20 is a perspective view of a utility knife incorporating yet another alternate quick release mechanism incorporating a rocker arm and coil spring;

FIG. 21 is an exploded perspective view of the utility knife of FIG. 20, illustrating the rocker arm and coil spring combination;

FIG. 22 is an inverted exploded perspective view of FIG. 21;

FIG. 23 is a side view of FIG. 20 taken along lines 23-23;

FIG. 24 is a cross-sectional view of FIG. 23 taken along lines 24-24, illustrating the internal alternate rocker arm knife blade release mechanism in the locked position;

FIG. 25 is another side view of FIG. 23 taken along lines 24-24, wherein the knife blade is in the unlocked position.

FIG. 26 is a side view of an alternative utility knife incorporating a rocker arm and coil spring;

FIG. 27 is a side view of utility knife of FIG. 26 taken along lines 27-27, illustrating the internal quick release mechanism in the locked position;

FIG. 28 is a side view of the utility knife of FIG. 26 taken along lines 27-27, wherein the quick release button is in the unlocked position;

FIG. 29 illustrates a perspective view of the utility knife of the present invention incorporated into a knife handle;

FIG. 30 is another perspective view of FIG. 29, wherein the knife blade is rotating from a closed position to an open position; and

FIG. 31 is another perspective view of FIG. 29, wherein the knife blade is in the open position.

### DETAILED DESCRIPTION OF THE PREFERRED EMBODIMENTS

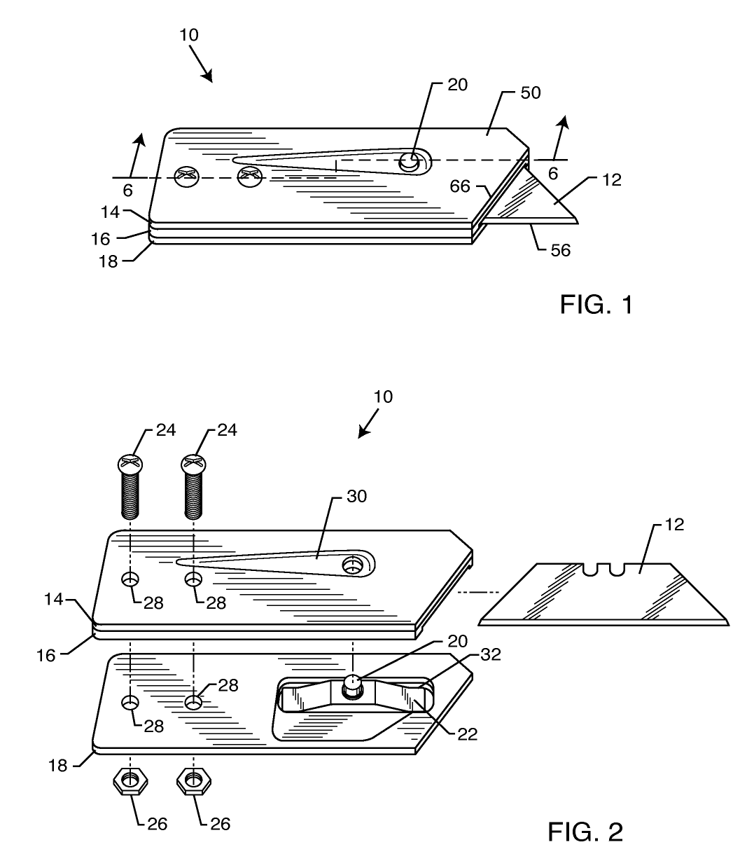

As shown in the exemplary drawings for purposes of illustration, the present disclosure for a utility knife is referred to generally by the reference numeral 10. Turning now to the representative figures in the specification, FIG. 1 illustrates a utility knife 10 incorporating a knife blade 12. In this embodiment, the utility knife 10 is constructed of three layers that include a top layer 14, an intermediate layer 16, and a bottom layer 18. It is conceived, however, that two or more layers could be used to form the utility knife 10. A release button 20 further facilitates the release or engagement of the knife blade 12 within the utility knife 10 via an actuator spring 22.

For the button 20 and the actuator spring 22 to properly function as a release or engagement mechanism, the top layer 14, intermediate layer 16, and the bottom layer 18 must be secured to one another in the form generally shown in FIG. 1. The bottom surface of the top layer 14 is facingly adjacent to the top surface of the intermediate layer 16. The top surface of the bottom layer 18 is thus facingly adjacent to the bottom surface of the intermediate layer 16. As shown in FIG. 1, the intermediate layer 16 is effectively sandwiched between the top layer 14 and the bottom layer 18. As further described herein, this sandwiched configuration in combination with the release button 20 and the actuator spring 22 enable the utility knife 10 to effectively accept and retain the knife blade 12.

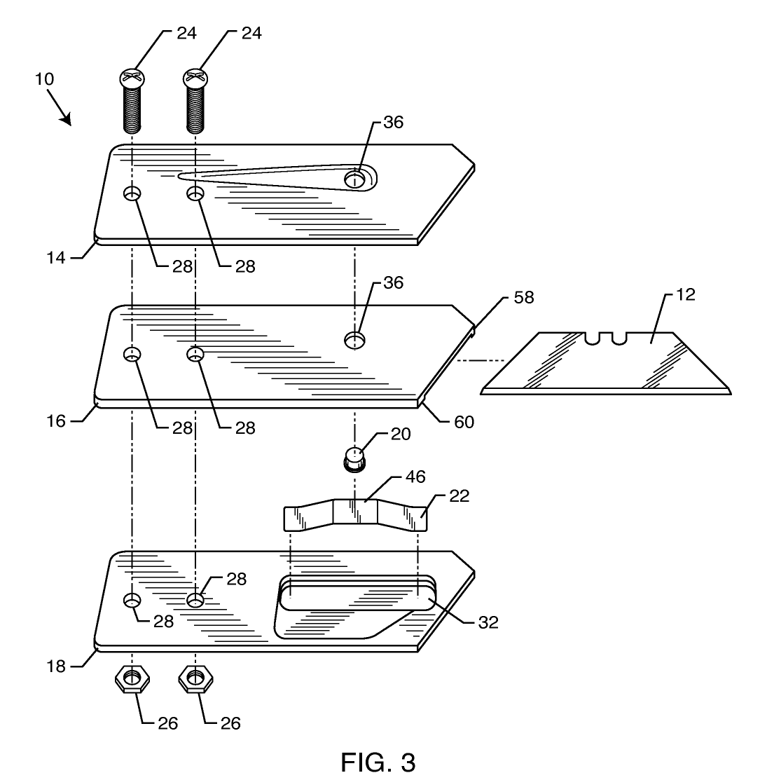

A variety of designs known in the art may be used to retain the top layer 14, the intermediate layer 16, and the bottom layer 18 in the sandwiched configuration of FIG. 1. In FIG. 2, a pair of screws 24 are shown extending vertically through the width of the utility knife 10 and engaging a pair of nuts 26 to secure the top layer 14, the intermediate layer 16, and the bottom layer 18 together. As better depicted in FIG. 3, the pair of screws 24 extend through a series of holes 28 in the top layer 14, in the intermediate layer 16, and in the bottom layer 18. In this embodiment, the pair of screws 24 may engage the pair of nuts 26 by threaded engagement or any other mechanism known in the art. Additionally, the pair of screws 24 and the pair of nuts 26 may be replaced by other securement devices having a similar function that are known in the art. Such securement devices might include clips, clamps, springs, bolts, rivets or welds. Additionally, it is conceived that chemical adhesives could be used to bind the bottom surface of the top layer 14 to the top surface of the intermediate layer 16 and to bind the top surface of the bottom layer 18 to the bottom surface of the intermediate layer 16. Thus, eliminating the need of a mechanical device. The important aspect of this sandwiched formation is that the release button 20 and the actuator spring 22 are tensioned against one another.

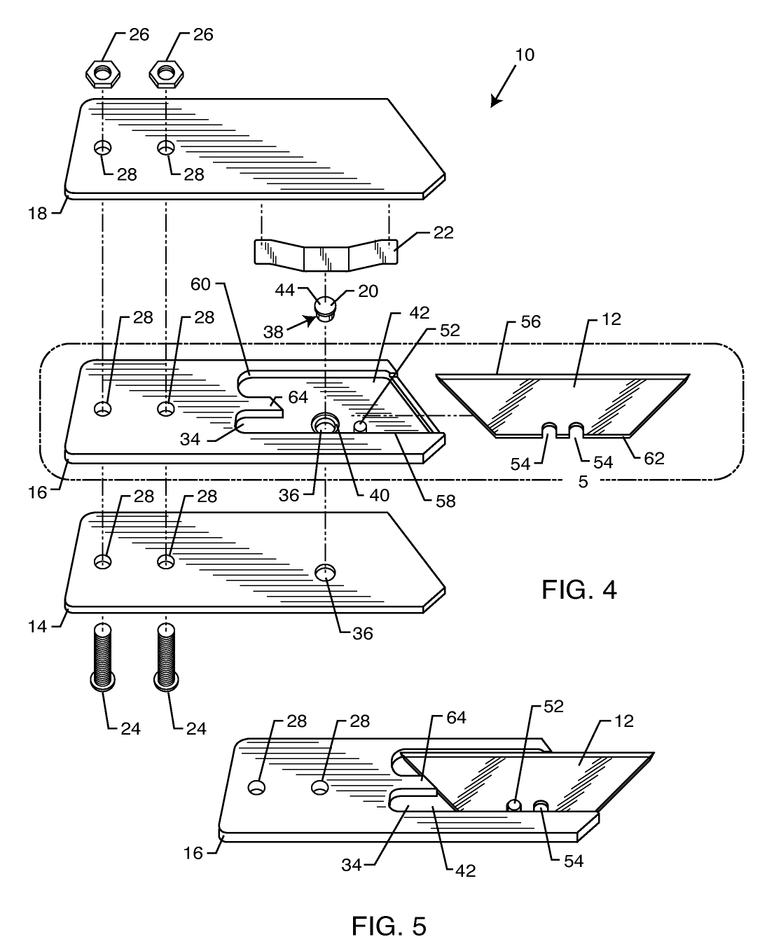

The utility knife 10 as shown in FIG. 2 illustrates the placement of the release button 20 with respect to the actuator spring 22. A groove 30 is etched into the top surface of the top layer 14 to provide ample fingertip engagement with the release button 20. The actuator spring 22 resides in a spring channel 32 (best shown in FIG. 3) and a spring guide 34 (best shown in FIG. 4) and is used to bias the release button 20 in an upward position. The release button 20 extends through a pair of release button holes 36 to protrude out from the top surface of the top layer 14 in the groove 30. The actuator spring 22 maintains the release button 20 in this protruding position. The combination of the release button 20 and the actuator spring 22 is the mechanism that locks or unlocks the knife blade 12 from the utility knife 10.

As shown in FIG. 4, the release button 20 has a retaining lip 38 that engages a retaining ledge 40 located beneath the surface of a knife blade channel 42. A head portion 44 of the release button 20 is preferably flush with the surface of the knife blade channel 42. Before the knife blade 12 is inserted into the knife blade channel 42, the head portion 44 of the release button 20 contacts a top surface 46 of the actuator spring 22. The actuator spring 22 resides in and is retained by the spring channel 32 in the bottom layer 18. The spring channel 32 prevents movement of the actuator spring 22 during use or transportation of the utility knife 10. The corresponding spring guide 34 in the intermediate layer 16 allows the actuator spring 22 to extend into a portion of the knife blade channel 42 for proper retainment of the knife blade 12 within the knife blade channel 42. The spring guide 34, like the spring channel 32, helps locate and prevent dislodgment of the actuator spring 22 during use or transportation. The top surface 46 of the actuator spring 22 is facingly adjacent to the head portion 44 of the release button 20. In this configuration, the release button 20 is pushed up by the actuator spring 22 through the release button holes 36 in the intermediate layer 16 and the top layer 14. The release button 20 is maintained in this upward position as protruding through the top surface of the top layer 14 and the groove 30 when the utility knife 10 is fully assembled.

As the knife blade 12 is inserted into the knife blade channel 42, the head portion 44 of the release button 20 and the top surface 46 of the actuator spring 22 are separated by the knife blade 12. When fully inserted, the knife blade 12 is wedged between the release button 20 and the actuator spring 22. In a particularly preferred embodiment, the top surface 46 of the actuator spring 22 is formed by a radiused edge to permit smooth insertion of the knife blade 12. Furthermore, the head portion 44 of the release button 20 is also preferably rounded to ease the insertion of the knife blade 12. But, a variety of spring and release button designs could be used pending insertion of the knife blade 12 may be automatically inserted into the utility knife 10. Once inserted, the knife blade 12 is substantially flush to the bottom surface of the knife blade channel 42, as best shown in FIG. 5. Release of the knife blade 12 is facilitated by depression of the release button 20.

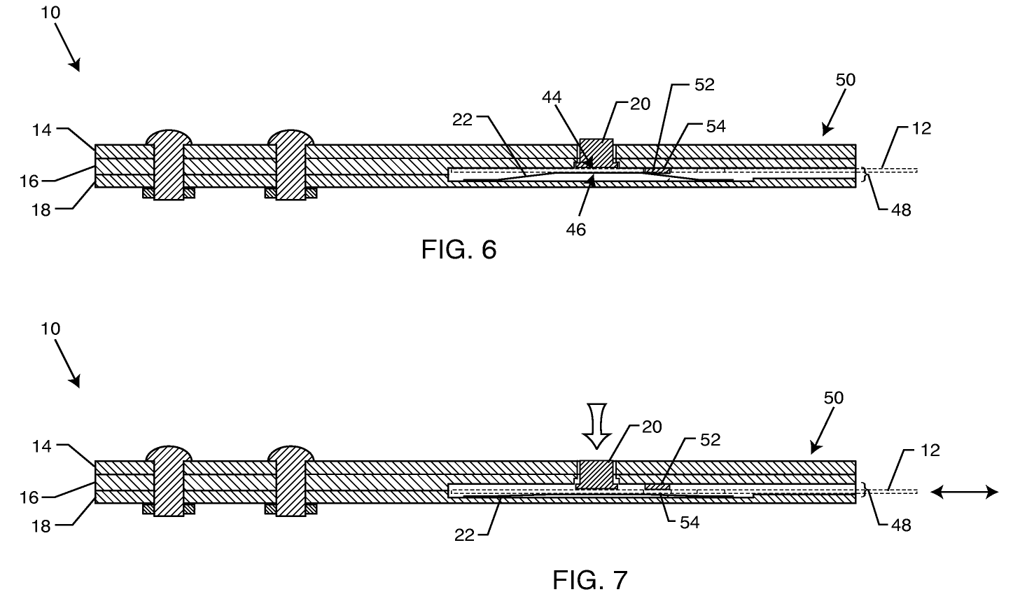

Protrusion of the release button 20 through the top surface of the top layer 14 enables external fingertip engagement by a user. The groove 30 formed in the top surface of the top layer 14 enables a user to depress the release button 20 by applying downward pressure thereon and thereafter effectively compressing the actuator spring 22 thereunder. Depression of the release button 20 from an initial position (FIG. 6) to a depressed position (FIG. 7) is the basis of the quick release mechanism that unlocks the knife blade 12 from within the knife blade channel 42 in the embodiments of FIGS. 1-7.

Insertion of the knife blade 12 into the knife blade channel 42 does not require depression of the release button 20. A user may simply slide the knife blade 12 into an insertion slot 48 (FIGS. 6 and 7) formed on a front end 50 of the utility knife 10 between the intermediate layer 16 and the bottom layer 18. As best shown in FIG. 6, once the knife blade 12 is fully inserted into the knife blade channel 42, the knife blade 12 is wedged between the top surface 46 of the actuator spring 22 and the head portion 44 of the release button 20. In this position, the knife blade 12 engages and is retained by a knob 52 (FIG. 4). The knob 52 is configured to engage any one of a pair of engagement slots 54 formed on one side of the knife blade 12. In the embodiment of FIG. 4, the knife blade 12 is configured in a trapezoidal shape such that the engagement slots 54 are located opposite a blade 56. As shown in FIG. 6, one of the engagement slots 54 fits snuggly into and is retained by the knob 52. It is contemplated in the present disclosure that the knob 52 and the engagement slots 54 could comprise a variety of shapes, sizes, or configurations, including multiple knobs. The important aspect is that there is a mechanism to retain the knife blade 12 in a substantially ridged position when inserted into the utility knife 10 via the release button 20 and the actuator spring 22.

When the knife blade 12 is fully inserted into the knife blade channel 42 and retained by the knob 52, the user should not experience substantial movement of the knife blade 12. In such a configuration, the knife blade 12 fits snugly within the housing of the knife blade channel 42. FIG. 5 is an exemplary illustration of the knife blade 12 situated in the knife blade channel 42 as retained by the knob 52 in engagement with one of the engagement slots 54. The knife blade channel 42 further includes a base guide edge 58 and a blade side guide edge 60 configured to fit the shape of the knife blade 12. When inserting the knife blade 12 within the insertion slot 48, the base guide edge 58 and the blade side guide edge 60 reside substantially parallel to and adjacent to a base side 62 and the blade 56, respectively, of the knife blade 12. Furthermore, an end stop 64 is angled to receive one side of the trapezoidal knife blade 12 to ensure proper location and engagement of at least one of the engagement slots 54 with the knob 52.

FIG. 6 illustrates the knife blade 12 as fully inserted into the utility knife 10. The knife blade 12 fits snuggly between the actuator spring 22 and the release button 20 in the knife blade channel 42. One of the engagement slots 54 is effectively retained by the knob 52. In this configuration, the utility knife 10 is in operational use.

Releasing the knife blade 12 from the utility knife 10 consists of a single disengagement step. Pressure is exerted along the directional arrow in FIG. 7 such that the release button 20 is depressed against the knife blade 12 and into the body of the knife blade channel 42. Accordingly, the actuator spring 22 also depresses to facilitate disengagement of the engagement slot 54 from the knob 52. In this position, the top of the knife blade 12 clears the bottom of the knob 52. The knife blade 12 is thus freely movable horizontally along the lines located at the front end 50 of the utility knife 10. In this disengaged configuration, a user may easily remove the knife blade 12 from the utility knife by simply grasping and pulling the knife blade 12 from the insertion slot 48. Once the knife blade 12 is removed, another new knife blade may be inserted or the utility knife 10 could be safely stowed without a knife blade for future use.

Additionally, the front end 50 of the utility knife 10 is configured for maximum exposure of the blade 56. As best shown in FIG. 1, the front end 50 contains an angled portion 66 that runs back along the length of the blade 56. The angled portion 66 provides additional exposure of the blade 56, thereby increasing cutting surface and efficiency of the utility knife 10 of the present invention. It is also conceived in the present invention that the configuration of the angled portion 66 could include multiple designs or shapes to maximize exposure of the blade 56. Other alternate embodiments of this concept are further illustrated below.

FIGS. 8-14 disclose a sample prior art embodiment of the utility knife 10. In FIG. 8, the top layer 14 is connected directly to the bottom layer 18 by the screw 24 and the nut 26 combination (FIG. 9). The top layer 14 and the bottom layer 18 could also be connected by any of the mechanisms or adhesives already described. In this embodiment, the utility knife 10 has a similar, yet shorter, groove 30 of which the release button 20 is accessible for fingertip engagement. Many different designs of the groove 30 are capable of being incorporated into the present invention pending adequate fingertip engagement is provided to actuate the corresponding spring. Additionally FIG. 8 discloses a radiused edge 68 that provides ample exposure of the blade 56 of the knife blade 12, similar to the angled portion 66 illustrated in FIG. 1.

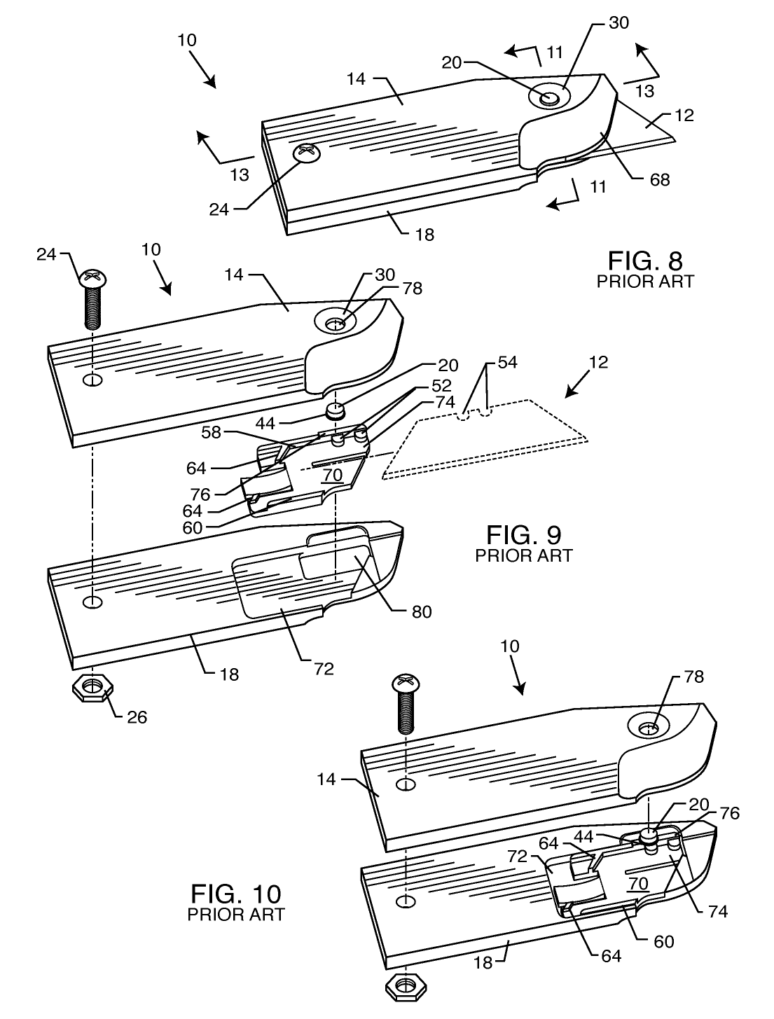

FIG. 9 illustrates an exploded view of the utility knife 10 incorporating a prior art blade release mechanism. The blade retaining mechanism shown in FIG. 9 is a clip 70 that is sandwiched between the top layer 14 and the bottom layer 18. The clip 70 resides in a clip channel 72 formed into the bottom layer 18. A spring arm 74 is integrally formed from the clip 70. The spring arm 74, as shown in FIG. 9 has the two knobs 52 formed therein to retain the knife blade 12 via the engagement slots 54. The two knobs 52 protrude from the clip 70 and are adjacent to an upper rail 76. As best shown in FIG. 11, the top portion of the upper rail 76 biases the head portion 44 of the release button 20 in an upward position. The release button 20 extends through a release aperture 78 formed in the top layer 14 and protrudes from the surface of the groove 30 for fingertip engagement. The release button 20 is effectively held in place by the spring arm 74. FIG. 10 better illustrates the placement of the clip 70 within the clip channel 72 of the bottom layer 18 for biasing the release button 20 in this upward position. When the clip 70 is seated within the clip channel 72 untensioned, the spring arm 74 is substantially parallel to the base of the clip channel 72.

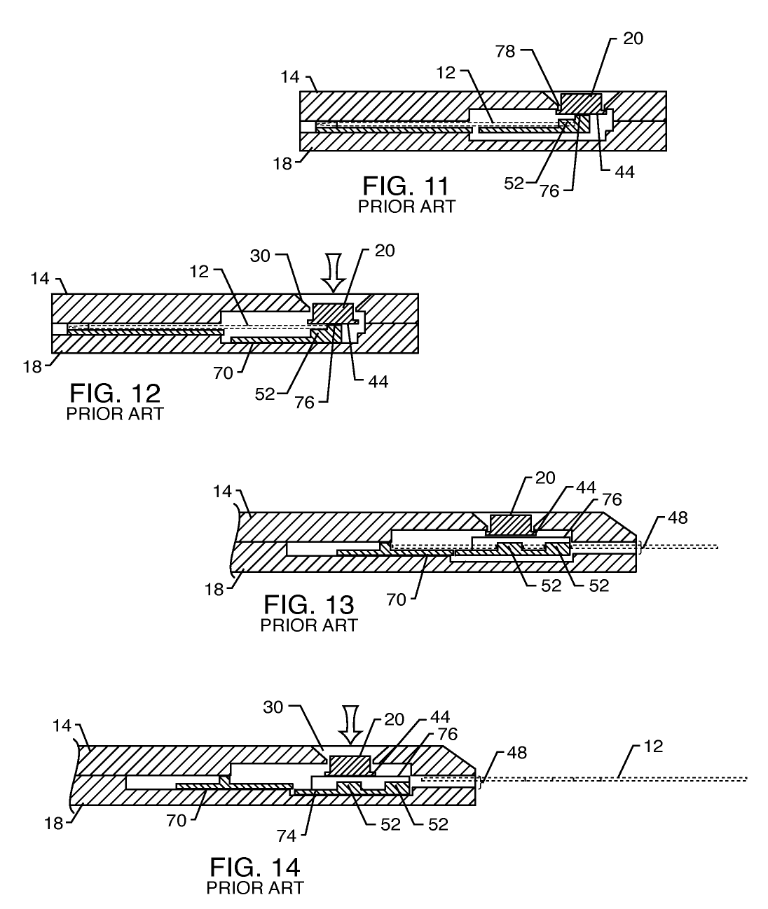

In operation, the release button 20 is depressed (shown best between FIGS. 11 and 12 and between FIGS. 13 and 14) such that the head portion 44 of the release button 20, as continually mated to the top surface of the upper rail 76, depresses the spring arm 74 into a spring arm channel 80 (FIG. 9). The groove 30 is configured to provide sufficient fingertip engagement to enable adequate depression of the release button 20 and the corresponding spring arm 74. Adequate depression requires that the spring arm 74 is depressed far enough into the spring arm channel 80 to disengage the knobs 52 from the engagement slots 54 of the utility blade 12. FIGS. 12 and 14 represent the knife blade 12 in the unlocked position such that the knife blade 12 can either be slidingly inserted or slidingly released from the clip 70.

In FIGS. 13-14, the knife blade 12 is inserted through the insertion slot 48 formed between the top layer 14 and the bottom layer 18. To insert the knife blade 12, the release button 20 and the spring arm 74 must be depressed into the spring arm channel 80 such that the knobs 52 are deflected below the surface level of the slide clip channel 72. This extra step prevents users from automatically inserting a replacement blade into the utility knife 10, unlike the embodiments of the present invention illustrated in FIGS. 1-7 and 15-31. Inadequate depression of the release button 20 and spring arm 74 will prevent insertion of the knife blade 12. Thus, the knife blade 12 can not be automatically inserted into the insertion slot 48 without interference with the knobs 52. Only after depression of the release button 20 and the spring arm 74 can insertion be accomplished. Upon insertion, the knife blade 12 is guided into the clip 70 by the base guide edge 58 and blade side guide edge 60 show best in FIGS. 9-10. The end stop 64 laterally aligns the utility blade 12 such that the pair of knobs 52 engage the engagement slots 54 when the release button 20 is no longer depressed and the spring arm 74 returns to an untensioned position.

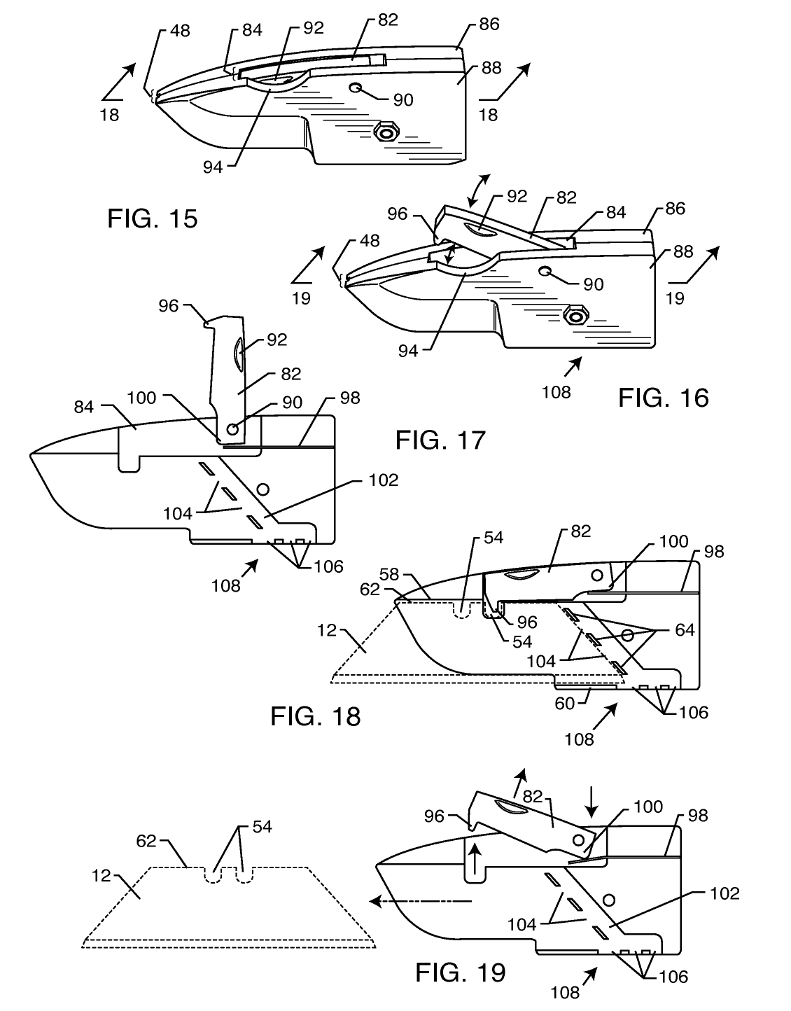

FIGS. 15-19 illustrate an alternative embodiment of a blade retention mechanism of the present invention. FIGS. 15-17 illustrate the motion of a rocker arm 82 disposed within a slot 84 formed from the assembly of a first body half 86 and a second body half 88. A pivot pin 90 is concentrically located within an aperture formed in the first body half 86 (not shown), an aperture formed in the second body half 88 (not shown) and an aperture formed in the rocker arm 82 (also not shown). The rocker arm 82 rotates within the slot 84 around the pivot pin 90. To move the rocker arm 82 from a locked position (FIGS. 15 and 18) to an unlocked position (FIGS. 16-17 and 19), an engagement slot 92 is utilized for fingernail engagement to rotate the rocker arm 82 upwardly along the arrows in FIG. 16. A recess 94 formed in the second body half 88 provides adequate fingernail engagement with the engagement slot 92.

The blade retention mechanism of FIGS. 15-19 enable a user to insert the knife blade 12 by either first moving the rocker arm 82 to an unlocked position or by simply automatically inserting the knife blade 12 into the insertion slot 48. Without first unlocking the rocker arm 82, users may insert the knife blade 12 into the insertion slot 48 by angling a portion of the knife blade 12 within the insertion slot 48. The rocker arm 82 is pushed upward slightly by the base side 62 of the knife blade 12 to enable the engagement slots 54 to automatically slide into place without the obstruction of a retainment finger 96 located at the end of the rocker arm 82.

Once the knife blade 12 is inserted into the insertion slot 48 and effectively retained by the retainment finger 96 of the rocker arm 82, the knife blade 12 cannot be removed without manually rotating the rocker arm 82 to the unlocked position via fingernail engagement through the engagement slot 92. Manual rotation of the rocker arm 82 is required because the retainment finger 96 is held in tension by a flat spring 98. When the rocker arm 82 is in the locked position, the flat spring 98 resides substantially untensioned in a slot formed as part of the first body half 86 and the second body half 88. As the rocker arm 82 is rotated to an unlocked position, an edge 100 of the rocker arm 82 rotates and deflects a portion of the flat spring 98 downwardly. In the configuration shown in FIG. 19, the flat spring 98 is tensioned and applies a force to the rocker arm 82 at the contact point with the edge 100. This force creates counter-clockwise rotational moment on the rocker arm 82. The rotational moment will rotate the rocker arm 82 back into the locked position of FIG. 18 with any displacement of the flat spring 98. Hence, the rocker arm 82 is retained in the locked position absent reactant forces to maintain the rocker arm 82 in the unlocked position. Yet, the knife blade 12 may be automatically inserted into the utility knife 10 without manually rotating the rocker arm 82 to the unlocked position.

Although, as shown in FIG. 17, if the rocker arm 82 is rotated to a position substantially perpendicular to the flat spring 98, the edge 100 loses contact with the flat spring 98. In FIG. 17, the flat spring 98 no longer exerts a rotational force on the rocker arm 82. Thus, the rocker arm 82 may reside in the substantially perpendicular position of FIG. 17 without rotating back to the locked position as previously described. In fact, the flat spring 98 now assumes the opposite role. The flat spring 98 will exert a force at the contact point of the edge 100 that creates a clockwise moment on the rocker arm 82. This opposite rotational moment will attempt to retain the rocker arm 82 in the perpendicular, unlocked position. But, once the rocker arm 82 is rotated beyond a threshold point, the flat spring 98 will again exert the counter-clockwise rotational force on the rocker arm 82 wherein the rocker arm 82 snaps back into the locked position.

Location of the knife blade 12 within the insertion slot 48 of the utility knife 10 is accomplished in a similar manner as the previous embodiments. As illustrated in FIG. 18, the base guide edge 58 and the corresponding blade side guide edge 60 vertically locate the knife blade 12 within the insertion slot 48. Additionally, the end stop 64 locates the knife blade 12 horizontally within the insertion slot 48. Once aligned, the retainment finger 94 is easily engageable with the engagement slot 54.

As an additional feature, FIGS. 17-19 illustrate a debris release slot 102 located behind the end stop 64. During the use of the utility knife 10, debris can get caught in the insertion slot 48, especially when the knife blade 12 is inserted or removed. If the end stop 64 did not contain a series of gaps 104, debris would get pushed back within the body of the utility knife 10. When a new knife blade 12 is inserted, the debris is trapped and even compacted against the end stop 64. Removal of the compacted debris necessarily requires the step of disassembling the utility knife 10. The series of gaps 104 as illustrated in FIGS. 17-19 provide access to the debris release slot 102 located behind the end stop 64. As the knife blade 12 is inserted into the insertion slot 48, any debris residing within the insertion slot 48 is pushed toward the end stop 64 and through the series of gaps 104 and into the debris release slot 102. Debris that would normally become trapped now resides in the debris release slot 102. Here, the debris will not restrict easy and full insertion of the knife blade 12 within the insertion slot 48. The debris exits through a series of exit points 106 formed on a bottom portion 108 between the first body half 86 and the second body half 88. Debris that would otherwise jam in the insertion slot 48 and prevent insertion of the knife blade 12 therein is effectively flushed out through the debris release slot 102 without disassembly the first body half 86 from the second body half 88.

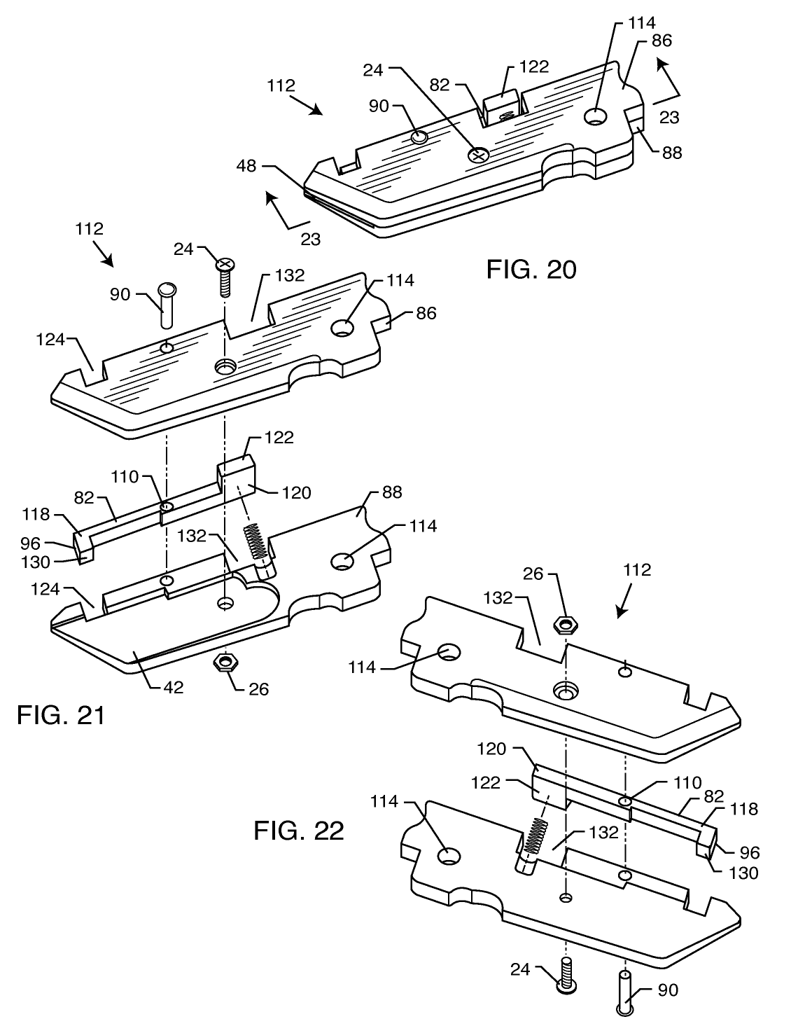

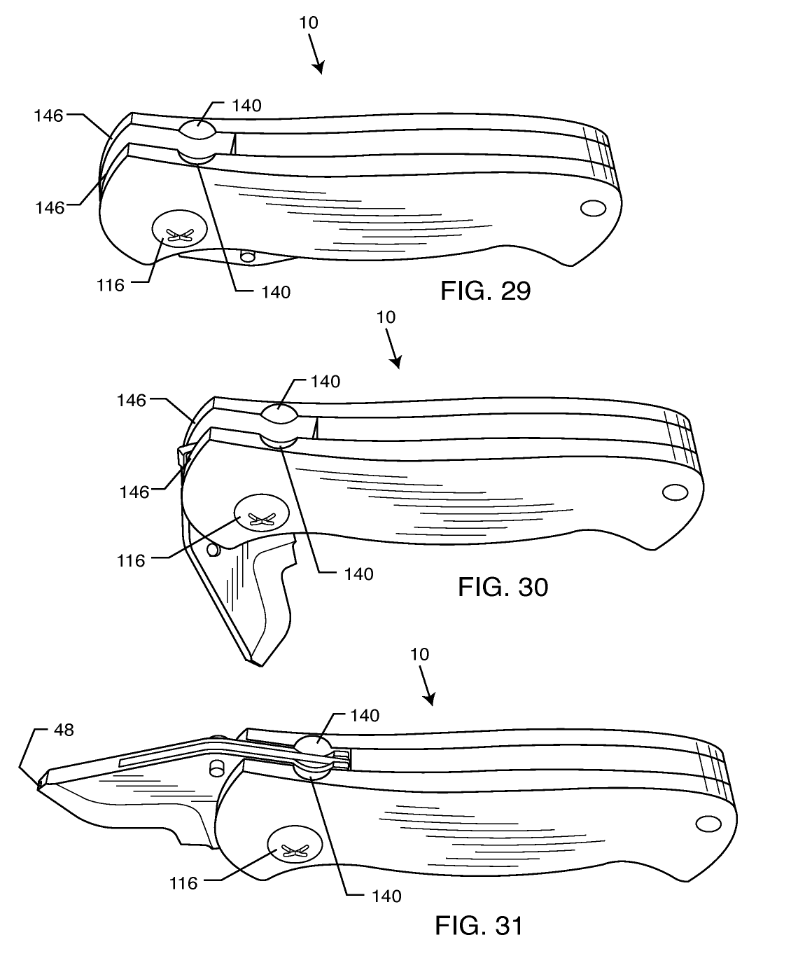

FIGS. 20-25 disclose another alternative embodiment of the present invention embodying a blade retention mechanism. It should be noted that the embodiments of FIGS. 20-25 disclose only a knife blade retainment head 112 of the utility knife 10. In FIG. 20, the rocker arm 82 resides within a slot (not shown) formed between the first body half 86 and the second body half 88. The first body half 86 and the second body half 88 are held together by any of the mechanical mechanisms or chemical adhesives as previously disclosed, including the combination of the screw 24 and the nut 26 shown in FIGS. 21-22. The rocker arm 82 includes a pivot aperture 110 which pivot pin 90 is concentrically located. A pair of knife body mounting apertures 114 formed in the first body half 86 and the second body half 88 are used in combination with a knife body screw 116 (FIGS. 29-31) to mount the knife blade retainment head 112 to the utility knife 10.

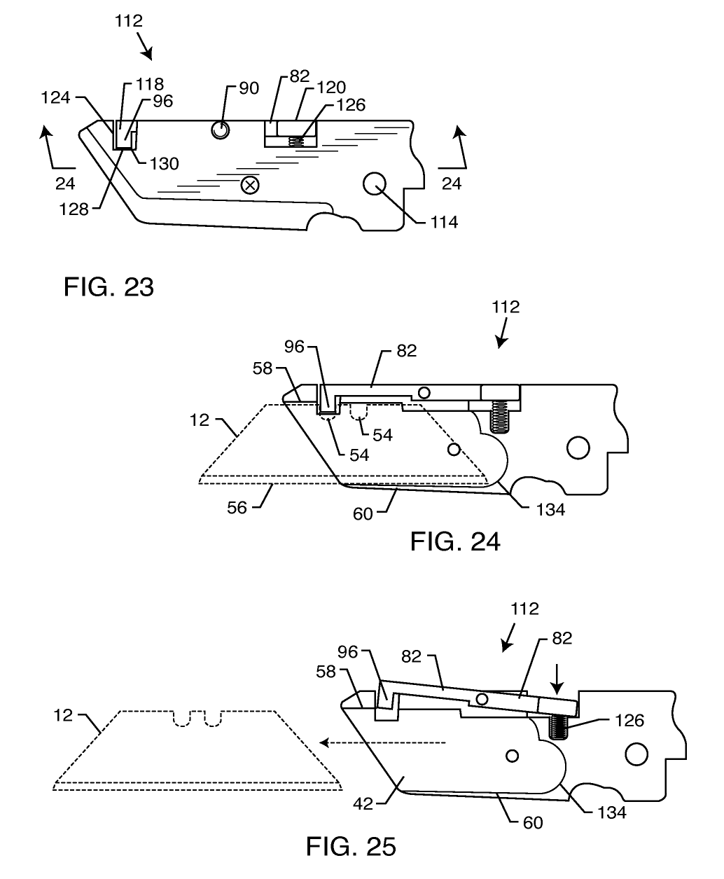

The rocker arm 82 has a first end 118 including the retainment finger 96 and a second end 120 including a button protrusion 122. The retainment finger 96 resides within a retainment finger slot 124 formed in the first body half 86 and formed in the second body half 88. When the knife blade retainment head 112 is fully assembled, as in FIG. 23, a coil spring 126 exerts a vertical force on the second end 120 of the rocker arm 82. This vertical force creates a counter-clockwise rotational moment on the rocker arm 82 around the pivot pin 90. In accordance with this counter-clockwise rotational moment, the first end 118 of the rocker arm 82 is forced within the retainment finger slot 124. A horizontal base 128 is preferably adjacent and flush with a bottom area 130 of the retainment finger 96. It is the horizontal base 128 that maintains the rocker arm 82 in a substantially horizontal position.

When the rocker arm 82 is in this horizontal position, as shown in FIGS. 23-24, the coil spring 126 remains tensioned. Absent the horizontal base 128, the coil spring 126 would continue rotating the rocker arm 82 about the pivot pin 90 until the coil spring 126 reached an untensioned state. The coil spring 126 maintains enough tension when the rocker arm 82 is in the horizontal position such that the retainment finger 96 retains the knife blade 12 within the insertion slot 48 via at least one of the engagement slots 54 as shown in FIG. 24. In FIG. 25, the coil spring 126 is further depressed and tensioned by applying the external force along the illustrated arrow. A pair of button gaps 132 (best shown in FIGS. 21-22) formed in the first body half 86 and formed in the second body half 88 provide adequate fingertip engagement of the second end 120 to adequately depress the button protrusion 122. Further depression of the coil spring 128 rotates the rocker arm 82 clockwise. The retainment finger 96 is effectively raised out of the knife blade channel 42. The knife blade 12 is then freely movable laterally within the insertion slot 48. Absent pressure exerted along the arrow in FIG. 25, the rocker arm 82 would return to the substantially horizontal position as shown in FIG. 24. The rocker mechanism of FIGS. 15-31 have the same functionality regardless whether rotation of the rocker arm 82 is clockwise or counter-clockwise.

As in previous embodiments, the base guide edge 58 and the blade side guide edge 60 locate the knife blade 12 within the insertion slot 48. In embodiment of FIG. 24, a radius edge stop 134 contacts a portion of the blade 56 to locate the knife blade 12 horizontally within the insertion slot 48. The combination of the base guide edge 58, the blade side guide edge 60, and the radius edge stop 134 guide the placement of the engagement slots 54 such that when the knife blade 12 is fully inserted, the retainment finger 96 engages at least one of the engagement slots 54. The knife blade 12 thereafter resides snugly within the insertion slot 48.

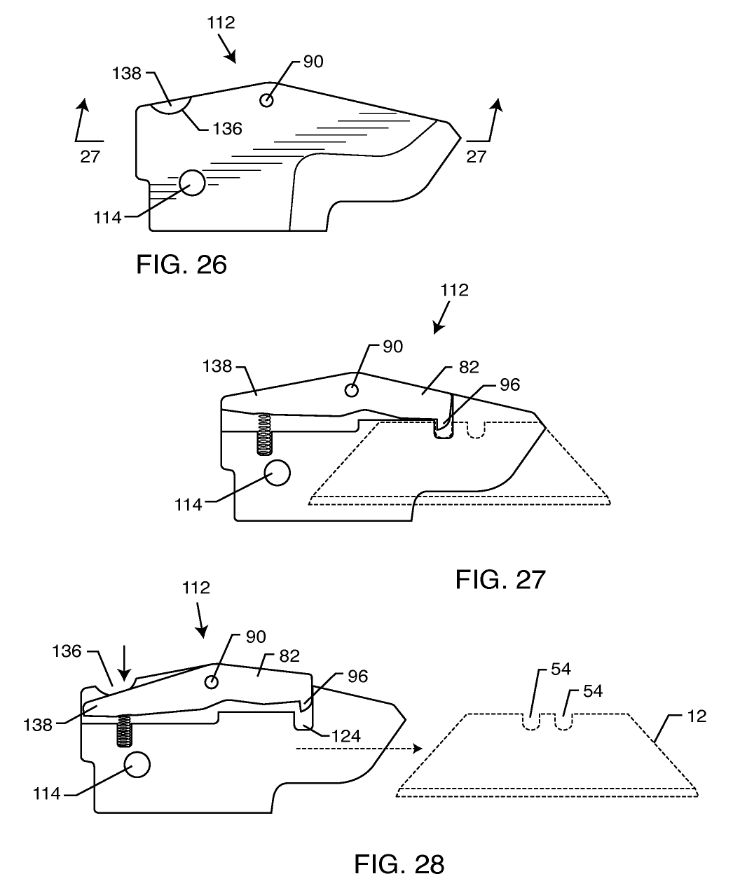

FIGS. 26-28 show an alternative embodiment of the knife blade retaining head 112 of FIGS. 20-25. Like the embodiments in FIGS. 20-25, the knife retainment head 112 of FIGS. 26-28 is also capable of being incorporated into the utility knife 10 of FIGS. 29-31 via the knife body mounting aperture 114 and the corresponding knife body screw 116. As shown in FIGS. 26-28, a recess 136 provides fingertip access to a rear portion 138 of the rocker arm 82. Depression of the rocker arm 82 along the arrow shown in FIG. 28 rotates the rocker arm 82 counter-clockwise. The coil spring 126 is depressed and the retainment finger 96 is raised from within the retainment finger slot 124. The knife blade 12 is then freely movable for insertion or removal from the insertion slot 48 (FIG. 31). The retainment finger 96 would no longer engage any one of the engagement slots 54 of the knife blade 12. Once pressure is released from the rocker arm 82, along the arrow in FIG. 28, the rocker arm 82 rotates back to the position in FIG. 27 along the pivot pin 90.

The incorporation of the recess 136 in combination with a pair of handle recesses 140 formed in a first handle half 142 and a second handle half 144 provide adequate fingertip engagement of the rear portion 138 of the rocker arm 82. When the knife blade retainment head 112 is integrated into the utility knife 10 in FIGS. 29-31, the rear portion 138 is only accessible when the knife blade retainment head 112 is rotated into the fully extended position as shown in FIG. 31. When the knife blade retainment head 112 is either in the fully closed posited of FIG. 29 or in intermediate position as shown in FIG. 30, the radius configuration of a handle front 146 prevents fingertip engagement of the rear portion 138 of the rocker arm 82. The radius configuration of the handle front 146 prevents any inadvertent unlocking of the retainment finger 96 from either of the engagement slots 54 when the knife blade retainment head 112 is not in the fully extended position of FIG. 31. The rear portion 138 of the rocker arm 82 is only accessible for releasing the knife blade 12 via the recess 136 in the knife blade retainment head 112 and the handle recesses 140 formed in the first handle half 142 and the second handle half 144.

The first handle half 142 and the second handle half 144 may be held together by any of the securement devices or adhesives as previously disclosed, including the knife body screw 116.

Although various embodiments have been described in detail for purposes of illustration, various modifications may be made without departing from the scope and spirit of the invention.

What is claimed is:

1. A utility knife, comprising:
a handle;
a replaceable blade having a lock retention notch; and
a blade lock mechanism including a blade lock associated with the handle which automatically engages the lock retention notch on insertion of the blade into the handle, the blade lock mechanism further including means for manually disengaging the blade lock from the lock retention notch in order to remove the blade from the handle.

2. The utility knife of claim 1, wherein the blade lock mechanism comprises a spring and a lock release mechanism manually actuable by the spring.

3. The utility knife of claim 2, wherein the spring compresses into a chamber in the handle by the lock release mechanism.

4. The utility knife of claim 2, wherein the spring comprises a cantilever spring, a flat spring or a coil spring.

5. The utility knife of claim 2, wherein the blade is sandwiched between the spring and the lock release mechanism.

6. The utility knife of claim 2, wherein the lock release mechanism comprises a button externally accessible from the handle.

7. The utility knife of claim 1, wherein the blade lock mechanism depresses the blade within a slot formed in the handle in order to disengage the blade lock from the lock retention notch.

8. The utility knife of claim 1, wherein the blade lock is attached to the handle.

9. The utility knife of claim 1, wherein the blade lock mechanism is pivotally coupled to the handle.

10. The utility knife of claim 9, wherein the blade lock mechanism comprises a pivotable arm and a spring coupled to a proximate end of the arm.

11. The utility knife of claim 10, wherein the blade lock is located on a distal end of the arm.

12. The utility knife of claim 10, including a recess in the handle for providing access to the proximate end of the arm.

13. The utility knife of claim 12, wherein the handle includes a collar for preventing access to the proximate end of the arm when the blade pivots out from a fully extended position, thereby preventing the blade lock from disengaging the lock retention notch.

14. The utility knife of claim 10, wherein the spring comprises a cantilever spring, a flat spring or a coil spring.

15. The utility knife of claim 1, including a guide for aligning the blade in the handle.

16. The utility knife of claim 1, including an angled handle head further exposing a cutting edge of the blade.

17. The utility knife of claim 1, including a debris release channel in the handle.

18. A utility knife, comprising:
a handle;
a replaceable blade having a lock retention notch; and
a blade lock mechanism comprising a spring manually actuable by a lock release mechanism; and
a blade lock attached to the handle which automatically engages the lock retention notch on insertion of the blade into the handle, the blade lock mechanism further including means for manually disengaging the blade lock from the lock retention notch in order to remove the blade from the handle.

19. The utility knife of claim 18, wherein the lock release mechanism compresses the spring into a chamber in the handle and depresses the blade within a slot formed in the handle in order to disengage the blade lock from the lock retention notch.

20. The utility knife of claim 18, wherein the blade is sandwiched between the spring and the lock release mechanism, the spring comprises a cantilever spring, a flat spring or a coil spring.

21. The utility knife of claim 18, wherein the lock release mechanism comprises a button externally accessible from the handle.

22. The utility knife of claim 18, including a guide for aligning the blade in the handle and a debris release channel in the handle.

23. The utility knife of claim 18, including an angled handle head further exposing a cutting edge of the blade.

24. A utility knife, comprising:
a handle;
a replaceable blade having a lock retention notch;
a blade lock mechanism pivotally coupled to the handle, comprising a pivotable arm and a spring, wherein the spring is coupled to a proximate end of the arm;
a blade lock located on a distal end of the arm, wherein the blade lock automatically engages the lock retention notch on insertion of the blade into the handle, the blade lock mechanism further including means for manually disengaging the blade lock from the lock retention notch in order to remove the blade from the handle; and
a guide for aligning the blade in the handle.

25. The utility knife of claim 24, including a recess in the handle for providing access to the proximate end of the arm and a collar for preventing access to the proximate end of the arm when the blade pivots out from a fully extended position, thereby preventing the blade lock from disengaging the lock retention notch.

26. The utility knife of claim 24, wherein the spring comprises a cantilever spring, a flat spring or a coil spring.

27. The utility knife of claim 24, including an angled handle head further exposing a cutting edge of the blade and a debris release channel in the handle.
